(19) United States
(12) Patent Application Publication
(10) Pub. No.: US 2024/0172101 A1
(43) Pub. Date: May 23, 2024

(54) METHOD FOR ADJUSTING TERMINAL NETWORK CAMPING POLICY, TERMINAL, AND STORAGE MEDIUM

(71) Applicant: REALME CHONGQING MOBILE TELECOMMUNICATIONS CORP., LTD., Chongqing (CN)

(72) Inventor: Yuqing Wu, Chongqing (CN)

(21) Appl. No.: 18/430,382

(22) Filed: Feb. 1, 2024

Related U.S. Application Data
(63) Continuation of application No. PCT/CN2022/105186, filed on Jul. 12, 2022.

(30) Foreign Application Priority Data
Aug. 3, 2021 (CN) 202110887804.8

(51) Int. Cl. H04W 48/16; H04W 16/08; H04W 28/08

(52) U.S. Cl. CPC H04W 48/16; H04W 28/0838; H04W 16/08

(57) ABSTRACT

Provided are a method for adjusting a network camping policy of a terminal, a terminal, and a non-transitory computer-readable storage medium. In the method, the first terminal receives first network state information sent by at least one second terminal. The first network state information indicates whether a cell accessed by the second terminal within a preset time period is a cell of network anomaly. The first terminal adjusts a network camping policy of the first terminal, according to the first network state information and cell measurement information of candidate cells of the first terminal.

### CROSS-REFERENCING OF RELEVANT APPLICATIONS

This application is a continuation of International Patent Application No. PCT/CN2022/105186, filed Jul. 12, 2022, which claims priority to a Chinese patent application No. 202110887804.8 filed Aug. 3, 2021, both of which are herein incorporated by reference in their entireties.

### TECHNICAL FIELD

The present disclosure relates to the field of communication technology, and in particular, it relates to a method for adjusting a network camping policy of a terminal (that is, a policy for a terminal to camp on a network), a terminal, and a non-transitory storage medium.

### BACKGROUND

At present, the deployment of 5G network is in the ascendant, and a coverage area of 5G cells is relatively smaller than a coverage area of 4G. For a terminal, cell handover is frequently performed between different 5G cell coverage areas; and after the terminal accesses a cell (camps on a network), if it founds a problem in a network state of the current cell, a network camping policy of the terminal may be adjusted (to select other cells for accessing).

However, the above-mentioned adjustment of the network camping policy of the terminal is only performed after the founding of the problem in the network state of the current cell, which adjustment is lagging and leads to a poor network service quality.

### SUMMARY

Embodiments of the present disclosure provide a method for adjusting a network camping policy of a terminal, a terminal and a non-transitory storage medium.

In a first aspect, a method for adjusting a network camping policy of a terminal is provided, and the method includes: receiving, by a first terminal, first network state information sent by at least one second terminal, the first network state information indicating whether a cell which accessed by the at least one second terminal within a preset time period is a cell of network anomaly; and adjusting, by the first terminal, a network camping policy of the first terminal, according to the first network state information and cell measurement information of candidate cells of the first terminal.

In a second aspect, a terminal is provided. The terminal includes a memory and a processor. The memory stores a computer program which, when be executed by the processor, causes the processor to: receive first network state information sent by at least one further terminal located in a same preset area as the terminal, the first network state information indicating whether a cell accessed by the at least one further terminal within a preset time period is a cell of network anomaly; and adjust a network camping policy of the terminal, according to the first network state information and cell measurement information of candidate cells of the terminal.

In a third aspect, a non-transitory computer-readable storage medium is provided. The medium stores thereon a computer program which, when being executed by a terminal, causes the terminal to: receive first network state information sent by at least one further terminal located in a same preset area as the terminal, the first network state information indicating whether a cell accessed by the at least one further terminal within a preset time period is a cell of network anomaly; and adjust a network camping policy of the terminal, according to the first network state information and cell measurement information of candidate cells of the terminal.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

In order to provide clearer explanation of the technical schemes in the embodiments of the present application or in the related art, the accompanying drawings required in the description of the embodiments or the related art are simply introduced below. It is evident that the accompanying drawings in the following description are only some embodiments of the present application. For those skilled in the art, other accompanying drawings can be obtained based on these drawings without any creative effort.

FIG. 1 is a diagram illustrating an application environment in which a method for adjusting a network camping policy of a terminal is applied according to an embodiment.

FIG. 2 is a flowchart of a method for adjusting a network camping policy of a terminal according to an embodiment.

FIG. 3 is a flowchart of a method for adjusting a network camping policy of a terminal according to an embodiment.

FIG. 4 is a flowchart of a method for adjusting a network camping policy of a terminal according to an embodiment.

FIG. 5 is a flowchart of a method for adjusting a network camping policy of a terminal according to an embodiment.

FIG. 6 is a flowchart of a method for adjusting a network camping policy of a terminal according to an embodiment.

FIG. 7 is a flowchart of a method for adjusting a network camping policy of a terminal according to an embodiment.

FIG. 8 is a structural block diagram of an apparatus for adjusting a network camping policy of a terminal according to an embodiment.

FIG. 9 is a structural block diagram of an apparatus for adjusting a network camping policy of a terminal according to an embodiment.

FIG. 10 is a structural block diagram of an apparatus for adjusting a network camping policy of a terminal according to an embodiment.

FIG. 11 is a schematic structural diagram of an electronic device according to an embodiment.

### DETAILED DESCRIPTION OF EMBODIMENTS

In order to make the purposes, technical schemes and advantages of the present disclosure more clear, the present disclosure is further described in detail with reference to the attached drawings and the embodiments. It is notable that the embodiments described herein are only used to illustrate the present disclosure, rather than limiting the present disclosure.

It is understandable that the terms “first”, “second” and the like used in the present disclosure may be used to describe various elements herein, but these elements are not limited by these terms. These terms are only used to distinguish a first element from another element. For example, without departing from the scope of the present disclosure, a first client may be named as a second client, and similarly, a second client may be named as a first client. Both the first client and the second client are clients, but they are not the same client.

The embodiments of the present disclosure provide a method and apparatus for adjusting a network camping policy of a terminal, a terminal and a non-transitory storage medium, by which the network camping policy can be adjusted, based on network state information of a cell shared by other terminals, before or after the terminal camps on a network, thereby optimizing the network service quality. According to the method for adjusting a network camping policy of a terminal, the terminal and the non-transitory storage medium, the first terminal receives the first network state information sent by at least one second terminal, and the first terminal adjusts the network camping policy of the first terminal, according to the first network state information and the cell measurement information of the candidate cells of the first terminal. The first network state information indicates whether the cell accessed by the second terminal within a preset time period is a cell of network anomaly. In the method, the first terminal may receive, from other second terminals, network state information of cells assessed by the other second terminals, that is, the second terminal could share the network state information of its accessed cell to the first terminal in time after obtaining such network state information, thereby avoiding the first terminal from spending time in collecting the network state information of different cells. Moreover, since the network state information indicates whether the cell accessed by the second terminal within the preset time period is a cell of network anomaly, especially in a case that the network state information indicates that the cell accessed by the second terminal within the preset time period is a cell of network anomaly, it is no longer necessary for the first terminal to determine that this cell is a cell of network anomaly only after the first terminal itself accesses this cell; rather, the first terminal can know the cell of network anomaly according to the received network state information sent by the second terminal. As such, the network camping policy of the first terminal can be optimized based on the network state information, which improves the network quality of an accessed cell of the first terminal, and enables the first terminal to obtain, based on the optimized network camping policy, a network service with high quality. By the method, the network camping policy can be adjusted, based on network state information of a cell shared by other terminals, before or after the terminal camps on a network, thereby optimizing the network service quality.

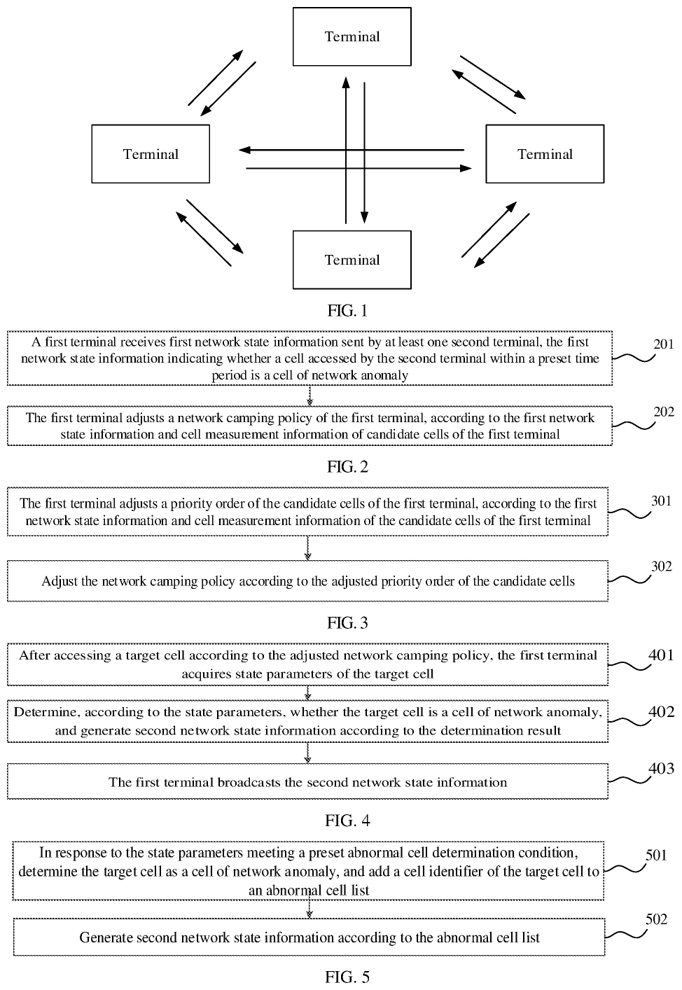

FIG. 1 is a diagram illustrating an application environment in which a method for adjusting a network camping policy of a terminal is applied according to an embodiment. As illustrated in FIG. 1, the application environment includes a plurality of terminals within a preset area, where each terminal may be a first terminal or a second terminal involved in the embodiments provided in FIGS. 2 to 6. That is, each terminal has an ability of sending network state information of a cell to at least one of other terminals located within the preset area, and also has an ability to receive network state information of a cell sent by at least one of the other terminals located within the preset area. In some implementations, the terminal may be any of intelligent terminals that have the ability of sending and receiving the network state information and use a 3GPP service, for example, a smart phone, a smart watch, a smart headphone, a smart car, a smart street lamp, and other intelligent devices involved in smart homes (an air conditioner, a refrigerator, a curtain, a television, and an access control system that may be networked).

FIG. 2 is a flowchart of a method for adjusting a network camping policy of a terminal according to an embodiment. In the embodiment, it is illustrated by taking a case where the method for adjusting a network camping policy of a terminal is executed by a first terminal which is any of the terminals illustrated in FIG. 1, as an example. As illustrated in FIG. 2, the method for adjusting a network camping policy of a terminal includes blocks 201 to 202.

In block 201, the first terminal receives first network state information sent by at least one second terminal, the first network state information indicating whether a cell accessed by the second terminal within a preset time period is a cell of network anomaly.

The first network state information refers to network state information of a cell accessed by the second terminal, which information is determined by the second terminal according to different network usage scenarios after accessing the cell. Since the network state of a cell may change based on many environmental factors, that is, since the network state of a cell is time-sensitive, the first network state information herein refers to network state information of a cell accessed by the second terminal within the preset time period. The network state information may indicate that the network state of the accessed cell is abnormal, or may indicate that the network state of the accessed cell is good. The first network state information may include a cell identifier, such as a cell ID, of the cell accessed by the second terminal within the preset time period. The first network state information may further include a flag bit indicating whether the network state is abnormal. For example, when the flag bit is 0, it is indicated that the network state of the accessed cell is abnormal; and when the flag bit is 1, it is indicated that the network state of the accessed cell is good.

In the method provided in the embodiments, information sharing is no longer performed between the terminal and a base station, but direct information sharing between terminals is performed. In some implementations, the first terminal and the second terminal are terminals located within a preset area and served by a same service provider; or, the first terminal and the second terminal are terminals located within a preset area and utilizing a same type of network.

In the embodiments, the first terminal and the second terminal may be terminals located within a preset area and served by a same service provider, for example, multiple terminals that are located within a certain building or a certain room and served by a same service provider. Specifically, the applicable scenario includes a conference room in which a multi-person conference is held. In this scenario, the terminals served by the same service provider has consistent network coverage. After a certain one terminal determines the network state information of its accessed cell, it may share the network state information with other terminals in time. If this accessed cell is determined to a cell of network anomaly, other terminals may be avoided from selecting this cell of network anomaly as a cell for accessing.

Alternatively, the first terminal and the second terminal may also be terminals located within a preset area and utilizing a same type of network. For example, the first terminal is a self-driving car and the second terminal is a mobile phone. The self-driving car and the mobile phone used by the driver or a passenger are served by a same service provider. In this case, the mobile phone may share the determined network state information of its accessed cell to the self-driving car, so that the self-driving car may optimize the network camping policy according to the network state information.

Alternatively, the way to perform the information sharing between the first terminal and the second terminal is not limited to Bluetooth, WIFI, and a local area network; alternatively, the first terminal and the second terminal may also perform data transmission via a network by means of a constructed third-party server. In the embodiments, the first terminal may receive, based on any of the data transmission methods mentioned above, the first network state information sent by the second terminal.

In block 202, the first terminal adjusts a network camping policy of the first terminal, according to the first network state information and cell measurement information of candidate cells of the first terminal.

The cell measurement information of the candidate cells of the first terminal refers to cell signal strength measurement values of nearby accessible cells that are detected by the first terminal. The first terminal may determine, based on the detected signal strength measurement values of the candidate cells, an order of signal strengths of the individual candidate cells. However, it is notable that the signal strength measurement value of a cell is not necessarily correlated directly to the network state of the cell, that is, a large signal strength measurement value of a cell does not mean a good network state of the cell. Because the accessed cell of the second terminal involved in the first network state information may also be one of the candidate cells detected by the first terminal, and the first network state information represents the network state of the cell, the first terminal may finely adjust a target to-be-accessed cell of the first terminal, according to the first network state information and the obtained signal strength measurement values of the candidate cells, that is, adjusting the network camping policy of the first terminal. In some implementations, if the first network state information indicates that the accessed cell of the second terminal is a cell of network anomaly, the first terminal may lower a priority of the cell of network anomaly, or the first terminal may reduce the signal strength measurement value of the cell of network anomaly, or the first terminal may directly bar the cell of network anomaly, or the first terminal may even directly disable the current network on which it camps, for example, the first terminal disables the 5G network and enables the 4G network, so as to update the first terminal's network camping policy, which is not limited in the embodiments.

In the method for adjusting a network camping policy of a terminal mentioned above, the first terminal receives the first network state information sent by at least one second terminal, and adjusts the network camping policy of the first terminal according to the first network state information and the cell measurement information of the candidate cells of the first terminal. The first network state information indicates whether the cell accessed by the second terminal within the preset time period is a cell of network anomaly. In the method, the first terminal may receive, from other second terminals, network state information of cells assessed by the other second terminals, that is, the second terminal could share the network state information of its accessed cell to the first terminal in time after obtaining such network state information, thereby avoiding the first terminal from spending time in collecting the network state information of different cells. Moreover, since the network state information indicates whether the cell accessed by the second terminal within the preset time period is a cell of network anomaly, especially in a case that the network state information indicates that the cell accessed by the second terminal within the preset time period is a cell of network anomaly, it is no longer necessary for the first terminal to determine that this cell is a cell of network anomaly only after the first terminal itself accesses this cell; rather, the first terminal can know the cell of network anomaly according to the received network state information sent by the second terminal. As such, the network camping policy of the first terminal can be optimized based on the network state information, which improves the network quality of an accessed cell of the first terminal, and enables the first terminal to obtain, based on the optimized network camping policy, a network service with high quality.

After receiving, from the second terminals, the network state information of their accessed cells, the first terminal may adjust and optimize the network camping policy based on the individual network state information. The first terminal may mark the cell of network anomaly according to the network state information, so that the marked cell of network anomaly is not considered during the selection of a cell for accessing. Alternatively, the first terminal may also rank all accessible cells. In an alternative embodiment, as illustrated in FIG. 3, the first terminal adjusting the network camping policy of the first terminal according to the network state information and the cell measurement information of the candidate cells of the first terminal, includes the following operations.

In block 301, the first terminal adjusts a priority order of the candidate cells of the first terminal, according to the first network state information and the cell measurement information of the candidate cells of the first terminal.

The cell measurement information of the candidate cells of the first terminal refers to the signal strength measurement values of the candidate cells. In a case where the first terminal does not access a cell, the signal strength measurement values of individual candidate cells may be obtained. In some implementations, after obtaining the signal strength measurement values of the individual candidate cells, the first terminal may prioritize the candidate cells according to their signal strength measurement values from large to small, that is, the larger the signal strength measurement value of a cell, the higher the priority of the cell.

In the embodiments, after obtaining a priority order of the individual candidate cells through the prioritization, the first terminal adjusts, according to the obtained first network state information, the priority order of the individual candidate cells. There are two adjustment situations. In one situation, when the first network state information indicates that the cell accessed by the second terminal is a cell of network anomaly, the priority of the cell of network anomaly is lowered. For example, the first terminal ranks the candidate cells according to the signal strength measurement values of the individual candidate cells, one cell, which is one of the candidate cells and has the strongest signal strength measurement value, ranks the first in the original priority order. After the first network state information is received, the cell is determined as a cell of network anomaly, then the first terminal may lower the ranking of the cell in the priority order, for example, the cell then ranks the second, the third or the fourth after the lowering of its priority. In the other situation, when the first network state information indicates that the cell accessed by the second terminal is a cell of good network, the priority of the cell of good network is raised. For example, the first terminal ranks the candidate cells according to the signal strength measurement values of the individual candidate cells, one cell, which is one of the candidate cells and has a relatively weak signal strength measurement value, ranks the third in the original priority order. After the first network state information is received, the cell is determined as a cell of good network, then the first terminal may raise the ranking of the cell in the priority order, for example, the cell then ranks the second or the first after the raising of its priority, which is not limited in the embodiments.

In some implementations, in the process of determining the priority order, the first terminal further needs to consider its own network connection state. In different network connection states, the first terminal needs to determine, in different ways, the priority order of the individual candidate cells. In an alternative embodiment, the first terminal prioritizing the candidate cells of the first terminal according to the first network state information and the cell measurement information of the candidate cells of the first terminal, and obtaining the priority order of the individual candidate cells, includes: prioritizing the candidate cells of the first terminal, according to a network connection state of the first terminal, the first network state information and the cell measurement information of the candidate cells of the first terminal, thereby obtaining the priority order of the individual candidate cells; where the network connection state indicates whether the first terminal accesses a cell.

The network connection state of the first terminal includes an idle state and a connected state. For the different network connection states of the first terminal, the first terminal needs to adopt different ways to prioritize the candidate cells. It is notable that, according to the actual situations, the network connection states of the first terminal have a temporal dependence, that is, the first terminal generally transits from the idle state to the connected state.

When the first terminal is in the idle state, if the first network state information indicates that the cell accessed by the second terminal within the preset time period is a cell of network anomaly, the priority of the cell of network anomaly is lowered in a priority list of the candidate cells. The idle state indicates that the first terminal accesses no cell, and the priority list of the candidate cells is generated by prioritizing the candidate cells according to the cell measurement information of the individual candidate cells.

The priority list of the candidate cells is generated by the first terminal through prioritizing accessible candidate cells based on the signal strength measurement values of the accessible candidate cells after obtaining such signal strength measurement values.

In the embodiments, when the first terminal is in the idle state, the first terminal automatically selects a cell for accessing. Thus, in this case, when the first terminal determines that the accessed cell of the second terminal is a cell of network anomaly, the first terminal may directly lower the priority of the cell of network anomaly. For example, if the cell of network anomaly ranks the first in the original priority list of the candidate cells, the first terminal may directly lower the ranking of the cell of network anomaly in the priority list of the candidate cells, and the cell then ranks for example the second, the third or the fourth after the lowering of its priority.

In another scenario, that is, when the first terminal is switched from the idle state to the connected state, and if the first network state information indicates that the cell accessed by the second terminal within the preset time period is a cell of network anomaly, the cell measurement information of the cell of network anomaly is modified, and the priority order of the candidate cells of the first terminal is adjusted according to the modified cell measurement information. The connected state indicates that the first terminal accesses a cell.

In the embodiments, when the first terminal is switched from the idle state to the connected state, that is, when the first terminal is in the connected state, the base station schedules a cell for the first terminal according to the cell measurement information of individual cells. The cell measurement information includes the signal strength measurement value of the cell. A large signal strength measurement value of a cell does not mean ta good network state of the cell. Therefore, in this case, when the accessed cell of the second terminal is a cell of network anomaly, in order to prevent the base station from scheduling the cell of network anomaly for the first terminal again, the first terminal may modify the signal strength measurement value of the cell of network anomaly. In some implementations, the first terminal may reduce the signal strength measurement value of the cell of network anomaly, so as to induce the base station to schedule, for the first terminal, another candidate cell rather than the cell of network anomaly. Furthermore, after modifying the signal strength measurement value of the cell of network anomaly, the first terminal may adjust, according to the modified cell measurement information of the cell of network anomaly, the priority order of the candidate cells of the first terminal, which is not limited in the embodiments.

In the embodiments, before the first terminal accesses a cell, if the first network state information indicates that the cell accessed by the second terminal within the preset time period is a cell of network anomaly, the first terminal may be prevented from accessing the cell of network anomaly by lowering the priority of the cell of network anomaly. After the first terminal accesses a cell, the priorities of the individual candidate cells may be adjusted for the second time, and the cell measurement information of the cell of network anomaly may be forcibly modified, thereby inducing the network to schedule, for the first terminal, a cell of a good network state.

In block 302, the network camping policy is adjusted according to the adjusted priority order of the candidate cells.

In the embodiments, after obtaining the adjusted priority order of candidate cells, the first terminal may take a cell with the highest priority as a target to-be-accessed cell. If a cell identifier of a to-be-accessed cell in the network camping policy is different from a cell identifier of the target to-be-accessed cell, the cell identifier of the to-be-accessed cell in the network camping policy is updated to the cell identifier of the target to-be-accessed cell, so as to obtain an adjusted and optimized network camping policy, which is not limited in the embodiments.

In the embodiments, the adjusted network camping policy is obtained after the first terminal prioritizes the candidate cells of the first terminal, according to the first network state information and the cell measurement information of the candidate cells of the first terminal. The first terminal may determine, based on the adjusted network camping policy, a candidate cell with the highest priority as the to-be-accessed cell, thus preventing the first terminal from accessing the cell of network anomaly.

The first terminal not only has the ability of receiving, from other second terminals, the network state information of cells accessed by other second terminals, and adjusting the network camping policy based on the network state information as mentioned above, but also has an ability of determining the network state information of the cell accessed by the first terminal itself and sending the network state information to other second terminals. In an alternative embodiment, as illustrated in FIG. 4, the above method further includes the following operations.

In block 401, after the first terminal access a target cell according to the adjusted network camping policy, the first terminal acquires state parameters of the target cell.

In the embodiments, the target cell refers to a cell that the first terminal finally accesses according to the adjusted network camping policy. According to the method provided in the embodiment of FIG. 3 mentioned above, the target cell is generally a cell with the highest priority among all candidate cells. After accessing the target cell, the first terminal may determine, based on different network usage scenarios, the state parameters of the target cell, where the state parameters include an uplink rate, a downlink rate, a network delay, a bit error rate, and times of resource release occurring in an application under the target cell, which are not limited in the embodiments.

In block 402, it is determined, according to the state parameters, whether the target cell is a cell of network anomaly, and second network state information is generated according to the determination result.

In the embodiments, the first terminal may determine whether the target cell is a cell of network anomaly according to the state information of the target cell obtained in block 401. In some implementations, the method for the first terminal to determine whether the target cell is a cell of network anomaly may be determined by referring to the situations for a cell of network anomaly in the embodiments provided in FIG. 5 mentioned below. As such, the first terminal may determine the second network state information of the target cell according to the determination result of the target cell, which is not limited in the embodiments.

In block 403, the first terminal broadcasts the second network state information.

In the embodiments, after determining the second network state information of the target cell, the first terminal may send the network state information to a plurality of other second terminals located within the preset area. The data transmission may also be performed through Bluetooth, WIFI, a local area network, or based on a third-party server, which is not limited in the embodiments.

In the embodiments, the first terminal may further broadcast the determined network state information of the cell accessed by itself to other second terminals located within the preset area, which realizes information sharing among all terminals, and improves the effectiveness of information under the background of big data.

There are many factors that affect the network state of each cell. The network state of each cell may change within a time period. The network of a cell is abnormal in a certain time period, and it may return to normal in the next time period. Based on this situation, in an alternative embodiment, as illustrated in FIG. 5, the above method further includes the following operations.

In block 501, in response to the state parameters meeting a preset abnormal cell determination condition, the target cell is determined as a cell of network anomaly, and the cell identifier of the target cell is added to an abnormal cell list.

The abnormal cell list includes the cell identifier(s) of the cell(s) of network anomaly that is(are) determined or received by the first terminal, and such cell identifier(s) is/are continuously updated by the first terminal and written into the abnormal cell list. The cell identifier may be a cell ID. The abnormal cell list may be a list generated through initialization before the first terminal leaves factory, or a list generated by the first terminal after acquiring or determining existence of a cell of network anomaly.

In some implementations, when the first terminal determines, based on the state parameters, whether the target cell is an abnormal cell, the determination is based on the preset abnormal cell determination condition. The preset abnormal cell determination condition include at least one of the following cases.

In case A, an uplink rate of the cell is always less than a first threshold within a first preset time, and/or a downlink rate of the cell is always less than a second threshold within a second preset time.

In the embodiments, if the first terminal determines that the uplink rate of its accessed cell is always lower than the first threshold within the first preset time, it shows that the accessed cell is a congested cell and time-frequency resources thereof are insufficient, and the accessed cell is determined as a cell of network anomaly. Similarly, if the first terminal determines that the downlink rate of its accessed cell is lower than the second threshold within the second preset time period, it shows that the accessed cell is a congested cell and the time-frequency resources thereof are insufficient, and the accessed cell is determined as a cell of network anomaly. In some implementations, the first preset time and the second preset time may be or may not be equal; and the first threshold and the second threshold may be or may not be equal.

In case B, when there is service in the cell, the number of times of releasing a configured time-frequency resource is greater than a third threshold.

In the embodiments, when there is service in the accessed cell, the first terminal releases the configured time-frequency resources for many times. For example, when running a game application, the first terminal releases the data bearer DRB for many times. In this case, the first terminal determines the accessed cell as a cell of network anomaly.

In case C, the number of times that the cell refuses a data connection of the terminal is greater than a fourth threshold.

In the embodiments, after the first terminal accesses the cell, many data connections initiated by the first terminal are rejected, which causes the data connection to be unavailable for the first terminal. In this case, the first terminal determines the accessed cell as a cell of network anomaly.

In case D, the number of times that a call is abnormally hung up in the cell is greater than a fifth threshold.

In the embodiments, the abnormal hanging up of a call is not a case where any of the calling and called parties hangs up actively. After the first terminal accesses the cell, the call is abnormally hung up many times. In this case, the first terminal determines the accessed cell as a cell of network anomaly.

In case E, a signal quality of the cell is lower than a signal quality of a neighbor cell, and the number of times that the terminal accesses the cell is greater than that number of times that the terminal accesses the neighbor cell.

In the embodiments, after the first terminal accesses the cell, it determines that the signal quality of the accessed cell is poor and the signal quality of the neighbor cell is good; however, the base station repeatedly schedules the terminal to the cell currently having a poor signal. In this case, the first terminal determines the accessed cell as a cell of network anomaly.

In the embodiments, when detecting that any one or at least one of the cases above exists in the accessed cell, the first terminal may determine the accessed cell as a cell of network anomaly. Of course, the way to determine whether the accessed cell is a cell of network anomaly is not limited to the cases mentioned above. For example, when the first terminal is running a game application, it may further determine, according to the network delay in the game, whether the network state of the accessed cell is abnormal.

In the embodiments, after determining that the accessed cell is a cell of network anomaly, the first terminal may write the cell identifier of the cell into the abnormal cell list. The first terminal also obtains the network state information sent by other second terminals, and when it determines that the network state information indicates that the accessed cell of the second terminal is a cell of network anomaly, the cell identifier of this accessed cell may also be written into the abnormal cell list, so as to updating the abnormal cell list.

In block 502, the second network state information is generated according to the abnormal cell list.

In the embodiments, after obtaining the abnormal cell list, the first terminal determines the second network state information according to the abnormal cell list. In this case, the second network state information includes the cell identifier, cell state information and the like of at least one cell of network anomaly determined by the first terminal.

In the embodiments, the first terminal aggregates information on the obtained or determined cells of network anomaly, so as to obtain the abnormal cell list, through which it can determine in real-time whether each cell is a cell of network anomaly. This avoids in time the terminal from being scheduled to these cells of network anomaly by the network, thereby indirectly optimizing the network service quality.

The network state of each cell may change within a period of time. Generally, after a period of time, the network state of each cell may be re-determined. In this case, in an alternative embodiment, as illustrated in FIG. 6, the above method further includes the following operations.

In block 601, a time duration during which each cell of network anomaly is listed on the abnormal cell list is acquired.

In the embodiments, when writing each cell of network anomaly into the abnormal cell list, the first terminal may acquire a time moment at which each cell of network anomaly is written into the abnormal cell list. In addition, by setting a timer, the first terminal may calculate a time duration during which each cell of network anomaly is listed on the abnormal cell list.

In block 602, in response to the time duration exceeding a preset time period, the cell identifier of a corresponding cell of network anomaly is removed from the abnormal cell list.

In the embodiments, if the time duration during which a cell of network anomaly is listed on the abnormal cell list exceeds the preset time period, it is construed that the network state of the cell may be re-determined, where the network state of the cell would have been optimized by the network side. In this case, the first terminal removes the cell identifier of this cell from the abnormal cell list. For example, the cell identifier may be cleared or erased, which is not limited in the embodiments.

In the embodiments, considering that the network state of the cell is changing in real time, the first terminal removes and updates, based on the time duration during which each cell of network anomaly is listed on the abnormal cell list, a cell(s) of network anomaly in the abnormal cell list, thus updating the information of the cells of network anomaly in the first terminal in time.

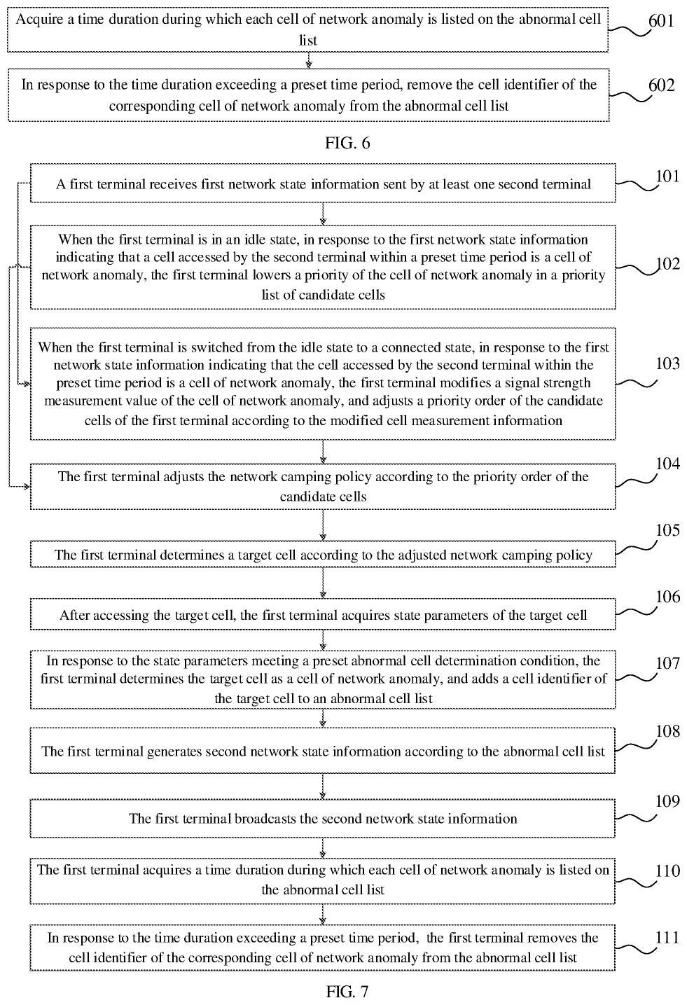

In some implementations, the embodiments provides an embodiment of a method for adjusting a network camping policy of a terminal. As illustrated in FIG. 7, the method includes the following operations.

In block 101, a first terminal receives first network state information sent by at least one second terminal.

In block 102, when the first terminal is in an idle state, and in response to the first network state information indicating that a cell accessed by the second terminal within a preset time period is a cell of network anomaly, the first terminal lowers a priority of the cell of network anomaly in a priority list of candidate cells.

In block 103, when the first terminal is switched from the idle state to the connected state, and in response to the first network state information indicating that the cell accessed by the second terminal within the preset time period is a cell of network anomaly, the first terminal modifies a signal strength measurement value of the cell of network anomaly, and adjusts a priority order of the candidate cells of the first terminal according to modified cell measurement information.

In block 104, the first terminal adjusts the network camping policy according to the priority order of the candidate cells.

In block 105, the first terminal determines a target cell according to the adjusted network camping policy.

In block 106, after accessing the target cell, the first terminal acquires state parameters of the target cell.

In block 107, in response to the state parameters meeting a preset abnormal cell determination condition, the first terminal determines the target cell as a cell of network anomaly, and adds a cell identifier of the target cell to an abnormal cell list.

In block 108, the first terminal generates second network state information according to the abnormal cell list.

In block 109, the first terminal broadcasts the second network state information.

In block 110, the first terminal acquires a time duration during which each cell of network anomaly is listed on the abnormal cell list.

In block 111, in response to the time duration exceeding a preset time period, the first terminal removes the cell identifier of a corresponding cell of network anomaly from the abnormal cell list.

In the embodiments, the first terminal may receive, from other second terminals, network state information of cells assessed by the other second terminals, that is, the second terminal could share the network state information of its accessed cell to the first terminal in time after obtaining such network state information, thereby avoiding the first terminal from spending time in collecting the network state information of different cells. Moreover, since the network state information indicates whether the cell accessed by the second terminal within the preset time period is a cell of network anomaly, especially in a case that the network state information indicates that the cell accessed by the second terminal within the preset time period is a cell of network anomaly, it is no longer necessary for the first terminal to determine that this cell is a cell of network anomaly only after the first terminal itself accesses this cell; rather, the first terminal can know the cell of network anomaly according to the received network state information sent by the second terminal. As such, the network camping policy of the first terminal can be optimized based on the network state information, which improves the network quality of an accessed cell of the first terminal, and enables the first terminal to obtain, based on the optimized network camping policy, a network service with high quality.

It is understandable that, although the blocks in the flowcharts of FIGS. 2-7 are displayed in sequence as indicated by arrows, these operations are not necessarily executed in sequence as indicated by the arrows. Unless explicitly stated herein, the execution order of these operations is not strictly limited, and these operations may be executed in other orders. Moreover, at least a part of the blocks in FIGS. 2-7 may include a plurality of sub-blocks or a plurality of stages, and these sub-blocks or stages may not necessarily be executed and completed at the same time, but may be executed at different times. These sub-blocks or stages may not necessarily be sequentially executed, but may be alternately or alternatively executed with other blocks or at least a part of the sub-blocks or stages of other blocks.

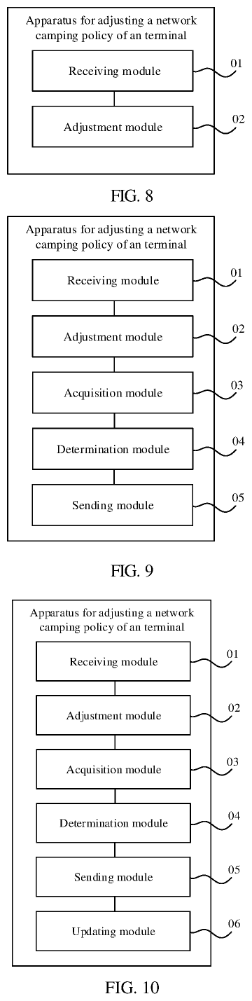

FIG. 8 is a structural block diagram of an apparatus for adjusting a network camping policy of a terminal according to an embodiment. As illustrated in FIG. 8, the apparatus for adjusting a network camping policy of a terminal is implemented in the first terminal, and it includes the following modules.
an receiving module 01, configured to receive first network state information sent by at least one second terminal, the first network state information indicating whether a cell accessed by the second terminal within a preset time period is a cell of network anomaly; and
an adjustment module 02, configured to adjust a network camping policy of the first terminal, according to the first network state information and cell measurement information of candidate cells of the first terminal.

In an alternative embodiment, the adjustment module 02 is configured to: adjust a priority order of the candidate cells of the first terminal, according to the first network state information and the cell measurement information of the candidate cells of the first terminal; and adjust the network camping policy according to the adjusted priority order of the candidate cells.

In an alternative embodiment, the adjustment module 02 is configured to: when the first terminal is in an idle state, and in response to the first network state information indicating that the cell accessed by the second terminal within the preset time period is a cell of network anomaly, lower a priority of the cell of network anomaly in a priority list of the candidate cells; where the idle state indicates that the first terminal access no cell, and the priority list of the candidate cells is generated by prioritizing the candidate cells according to the cell measurement information of the candidate cells.

In an alternative embodiment, the adjustment module 02 is configured to: when the first terminal is switched from the idle state to a connected state, and in response to the first network state information indicating that the accessed cell accessed by the second terminal within the preset time period is a cell of network anomaly, modify the cell measurement information of the cell of network anomaly, and adjust, according to the modified cell measurement information, the priority order of the candidate cells of the first terminal; where the connected state indicates that the first terminal accesses a cell.

In an alternative embodiment, the cell measurement information includes a signal strength measurement value, and the adjustment module 02 is configured to reduce the signal strength measurement value of the accessed cell of the second terminal.

In an alternative embodiment, as illustrated in FIG. 9, the apparatus for adjusting a network camping policy of a terminal further includes the following modules: an acquisition module 03, configured to acquire state parameters of a target cell, after the target cell is accessed according to the adjusted network camping policy; a determination module 04, configured to determine, according to the state parameters, whether the target cell is a cell of network anomaly, and generate second network state information according to the determination result; and a sending module 05, configured to broadcast the second network state information.

In an alternative embodiment, the determination module 04 is configured to: determine, in response to the state parameters meeting a preset abnormal cell determination condition, the target cell as a cell of network anomaly, and add the cell identifier of the target cell to an abnormal cell list; and generate the second network state information according to the abnormal cell list.

In an alternative embodiment, as illustrated in FIG. 10, the apparatus for adjusting a network camping policy of a terminal further includes: an updating module 06, further configured to: obtain a time duration during which each cell of network anomaly is listed on the abnormal cell list; and in response to the time duration exceeding a preset time period, remove the cell identifier of the corresponding cell of network anomaly from the abnormal cell list.

In an alternative embodiment, the cell of network anomaly includes at least one of the following situations: an uplink rate of the cell is always less than a first threshold within a first preset time; a downlink rate of the cell is always less than a second threshold within a second preset time; when there is service in the cell, the number of times of releasing a configured time-frequency resource is greater than a third threshold; the number of times that the cell refuses a data connection of the terminal is greater than a fourth threshold; the number of times that a call is abnormally hung up in the cell is greater than a fifth threshold; and a signal quality of the cell is lower than a signal quality of a neighbor cell, and the number of times that the terminal accesses the cell is greater than that number of times that the terminal accesses the neighbor cell.

In an alternative embodiment, the first terminal and the second terminal are terminals located within a preset area and served by a same service provider; or, the first terminal and the second terminal are terminals located within a preset area and utilizing a same type of network.

The division of the individual modules in the apparatus for adjusting a network camping policy of a terminal mentioned above is only for illustration. In other embodiments, the apparatus for adjusting a network camping policy of a terminal may be divided into different modules according to requirements, so as to complete all or part of the functions of the apparatus for adjusting a network camping policy of a terminal mentioned above.

For the specific definition of the apparatus for adjusting a network camping policy of a terminal, reference may be made to the definition of the method for adjusting a network camping policy of a terminal mentioned above, which is not repeated here. Each module in the apparatus for adjusting a network camping policy of a terminal mentioned above may be realized in whole or in part by software, hardware and a combination of the software and the hardware. Each of the modules mentioned above may be embedded in or independent of, in the form of hardware, the processor of a computer device, and may also be stored, in the form of software, in the memory of the computer device, so that the processor may call and execute the operations corresponding to the modules above.

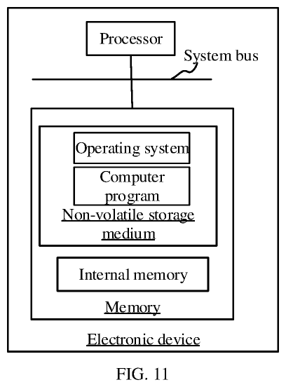

FIG. 11 is a schematic structural diagram of an electronic device according to an embodiment. The electronic device may be any terminal device such as a mobile phone, tablet computer, notebook computer, desktop computer, Personal Digital Assistant (PDA), Point of Sales (POS), vehicle-mounted computer, and wearable device. The electronic device may be the first terminal or the second terminal mentioned above. The electronic device includes a processor and a memory which are connected through a system bus. The processor may include one or more processing units. The processor may be for example a Central Processing Unit (CPU) or a Digital Signal Processing (DSP). The memory may include a non-volatile/non-transitory storage medium and an internal memory. The non-volatile/non-transitory storage medium stores an operating system and computer programs. The computer program may be executed by the processor to realize the method for adjusting a network camping policy for a terminal as provided by the embodiments mentioned above. The internal memory provides a cache running environment for the operating system of computer programs in the non-volatile storage medium.

Each module in the apparatus for adjusting a network camping policy for a terminal provided in the embodiments of the present disclosure may be realized in the form of a computer program. The computer program may be run on the terminal or the server. Program modules consisting the computer program may be stored in the memory of the electronic device. When the computer program is executed by a processor, the operations of the method described in the embodiments of the present disclosure are realized.

The embodiments of the present disclosure further provide a computer-readable storage medium. One or more non-transitory computer-readable storage medium include computer-executable instructions which, when being executed by one or more processors, cause the processors to execute the operations of the method for adjusting a network camping policy for a terminal.

The embodiments of the present disclosure further provide a computer program product including instructions which, when being executed on a computer, causes the computer to execute the method for adjusting a network camping policy for a terminal.

Any reference to memory, storage, database or other media used in the present disclosure may include the non-volatile memory and/or the volatile memory. The non-volatile memory may include read-only memory (ROM), programmable read-only memory (PROM), erasable programmable read-only memory (EPROM), electrically erasable programmable read-only memory (EEPROM) or flash memory. The volatile memory may include random access memory (RAM), which is used as an external cache memory. As illustration and not limitation, RAM is available in various forms, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), sync link dynamic random access memory (SLDRAM), rambus dynamic random access memory (RDRAM), and direct rambus dynamic random access memory (DRDRAM).

The embodiments mentioned above only describe several implementations of the present disclosure, and the description is specific and detailed, but it shall not be construed as a limitation of the scope of the present disclosure. It is notable that, for those skilled in the art, several modifications and improvements may be made without departing from the concept of the present disclosure, which are all within the protection scope of the present disclosure. Therefore, the scope of protection of the present disclosure shall be subject to the appended claims.

What is claimed is:

1. A method for adjusting a network camping policy of a terminal, comprising:
receiving, by a first terminal, first network state information sent by at least one second terminal, the first network state information indicating whether a cell accessed by the at least one second terminal within a preset time period is a cell of network anomaly; and
adjusting, by the first terminal, a network camping policy of the first terminal, according to the first network state information and cell measurement information of candidate cells of the first terminal.

2. The method of claim 1, wherein adjusting, by the first terminal, the network camping policy of the first terminal according to the first network state information and the cell measurement information of the candidate cells of the first terminal, comprises:
adjusting, by the first terminal, a priority order of the candidate cells of the first terminal, according to a network connection state of the first terminal, the first network state information and the cell measurement information of the candidate cells of the first terminal, the network connection state indicating whether the first terminal accesses a cell; and
adjusting the network camping policy according to the adjusted priority order of the candidate cells.

3. The method of claim 2, wherein the network connection state of the first terminal comprises an idle state and a connected state, adjusting the priority order of the candidate cells of the first terminal, according to the network connection state of the first terminal, the first network state information and the cell measurement information of the candidate cells of the first terminal, comprises:
while the first terminal is in the idle state, in response to the first network state information indicating that the cell accessed by the at least one second terminal within the preset time period is a cell of network anomaly, lowering a priority of the cell of network anomaly in a priority list of the candidate cells, wherein the idle state indicates that the first terminal accesses no cell, and the priority list of the candidate cells is generated by prioritizing the candidate cells according to the cell measurement information of the candidate cells.

4. The method of claim 3, wherein the method further comprises:
while the first terminal is switched to the connected state from the idle state, in response to the first network state information indicating that the cell accessed by the at least one second terminal within the preset time period is a cell of network anomaly, modifying the cell measurement information of the cell of network anomaly, and adjusting the priority order of the candidate cells of the first terminal according to the modified cell measurement information, wherein the connected state indicates that the first terminal accesses a cell; and
wherein the cell measurement information comprises a signal strength measurement value, and modifying the cell measurement information of the cell of network anomaly, comprises:
reducing the signal strength measurement value of the cell of network anomaly.

5. The method of claim 1, wherein the method further comprises:
after the first terminal accesses a target cell according to the adjusted network camping policy, acquiring state parameters of the target cell;
in response to the state parameters meeting a preset abnormal cell determination condition, determining the target cell as a cell of network anomaly, and adding a cell identifier of the target cell to an abnormal cell list;
generating, according to the abnormal cell list, second network state information; and
broadcasting, by the first terminal, the second network state information to the at least one second terminal;
wherein the state parameters comprise at least an uplink rate, a downlink rate, a network delay, a bit error rate, and times of resource release occurring in an application.

6. The method of claim 5, wherein the method further comprises:
acquiring a time duration during which each cell of network anomaly is listed on the abnormal cell list; and
in response to the time duration exceeding a preset time period, removing the cell identifier of a corresponding cell of network anomaly from the abnormal cell list.

7. The method of claim 5, wherein the preset abnormal cell determination condition comprises at least one of:
the uplink rate of the target cell being always less than a first threshold within a first preset time;
the downlink rate of the target cell being always less than a second threshold within a second preset time;
the number of times of releasing a configured time-frequency resource being greater than a third threshold, while there is service in the target cell;
the number of times, that the target cell refuses a data connection of the terminal, being greater than a fourth threshold;
the number of times, that a call is abnormally hung up in the target cell, being greater than a fifth threshold; and
a signal quality of the target cell being lower than a signal quality of a neighbor cell, and the number of times that the terminal accesses the target cell being greater than the number of times that the terminal accesses the neighbor cell.

8. The method of claim 1, wherein the first terminal and the second terminal are terminals located within a preset area and served by a same service provider; or
the first terminal and the second terminal are terminals located within a preset area and utilizing a same type of network.

9. A terminal, comprising a memory and a processor, wherein the memory stores a computer program which, when being executed by the processor, causes the processor to:
receive first network state information sent by at least one further terminal located in a same preset area as the terminal, the first network state information indicating whether a cell accessed by the at least one further terminal within a preset time period is a cell of network anomaly; and
adjust a network camping policy of the terminal, according to the first network state information and cell measurement information of candidate cells of the terminal.

10. The terminal of claim 9, wherein the computer program, when being executed by the processor, causes the processor further to:
adjust a priority order of the candidate cells of the terminal, according to a network connection state of the terminal, the first network state information and the cell measurement information of the candidate cells of the terminal, the network connection state indicating whether the terminal accesses a cell; and
adjust the network camping policy according to the adjusted priority order of the candidate cells.

11. The terminal of claim 10, wherein the network connection state of the terminal comprises an idle state, the idle state indicates that the terminal access no cell, and the computer program, when being executed by the processor, causes the processor further to:
when the terminal is in the idle state, in response to the first network state information indicating that the cell accessed by the at least one further terminal within the preset time period is a cell of network anomaly, lower a priority of the cell of network anomaly in a priority list of the candidate cells; wherein the priority list of the candidate cells is generated by prioritizing the candidate cells according to the cell measurement information of the candidate cells.

12. The terminal of claim 11, wherein the network connection state of the terminal further comprises a connected state, the connected state indicates that the terminal accesses a cell, and the computer program, when being executed by the processor, causes the processor further to:
when the terminal is switched from the idle state to the connected state, in response to the first network state information indicating that the accessed cell accessed by the at least one further terminal within the preset time period is a cell of network anomaly, modify the cell measurement information of the cell of network anomaly, and adjust, according to modified cell measurement information, the priority order of the candidate cells of the terminal.

13. The terminal of claim 12, wherein the cell measurement information comprises a signal strength measurement value, and the computer program, when being executed by the processor, causes the processor further to:
in response to the first network state information indicating that the accessed cell accessed by the at least one further terminal within the preset time period is a cell of network anomaly, reduce the signal strength measurement value of the cell of network anomaly.

14. The terminal of claim 9, wherein the computer program, when being executed by the processor, causes the processor further to:
acquire state parameters of a target cell, after the target cell is accessed by the terminal according to the adjusted network camping policy;
determine, according to the state parameters, whether the target cell is a cell of network anomaly, and generate second network state information according to a determination result; and
broadcast the second network state information to the at least one further terminal.

15. The terminal of claim 14, wherein the computer program, when being executed by the processor, causes the processor further to:
determine the target cell as a cell of network anomaly and add a cell identifier of the target cell to an abnormal cell list, in response to the state parameters meeting a preset abnormal cell determination condition; and
generate, according to the abnormal cell list, the second network state information.

16. The terminal of claim 14, wherein the state parameters comprise an uplink rate, a downlink rate, a network delay, a bit error rate, and times of resource release occurring in an application.

17. The terminal of claim 15, wherein the computer program, when being executed by the processor, causes the processor further to:
acquire a time duration during which each cell of network anomaly is listed on an abnormal cell list; and
in response to the time duration exceeding a preset time period, remove a cell identifier of a corresponding cell of network anomaly from the abnormal cell list.

18. The terminal of claim 15, wherein the preset abnormal cell determination condition comprises at least one of:
an uplink rate of the target cell being always less than a first threshold within a first preset time;
a downlink rate of the target cell being always less than a second threshold within a second preset time;
the number of times of releasing a configured time-frequency resource being greater than a third threshold, while there is service in the target cell;
the number of times, that the target cell refuses a data connection of the terminal, being greater than a fourth threshold;
the number of times, that a call is abnormally hung up in the target cell, being greater than a fifth threshold; and
a signal quality of the target cell being lower than a signal quality of a neighbor cell, and the number of times that the terminal accesses the target cell being greater than the number of times that the terminal accesses the neighbor cell.

19. The terminal of claim 9, wherein the terminal and the at least one further terminal are served by a same service provider or utilize a same type of network.

20. A non-transitory computer-readable storage medium storing a computer program thereon, wherein the computer program, when being executed by a terminal, cause the terminal to:
receive first network state information sent by at least one further terminal located in a same preset area as the terminal, the first network state information indicating whether a cell accessed by the at least one further terminal within a preset time period is a cell of network anomaly; and
adjust a network camping policy of the terminal, according to the first network state information and cell measurement information of candidate cells of the terminal.
